(19) United States
(12) Patent Application Publication
(10) Pub. No.: US 2015/0268734 A1
(43) Pub. Date: Sep. 24, 2015

(54) GESTURE RECOGNITION METHOD FOR MOTION SENSING DETECTOR

(71) Applicant: LIPS INCORPORATION, Taipei City (TW)

(72) Inventors: Ling-Wei LIU, Taipei City (TW); Hung-Chang TSAI, Taipei City (TW)

(73) Assignee: LIPS INCORPORATION, Taipei City (TW)

(21) Appl. No.: 14/265,172

(22) Filed: Apr. 29, 2014

(30) Foreign Application Priority Data
Mar. 21, 2014 (TW) 103110650

(51) Int. Cl. G06F 3/01

(52) U.S. Cl. CPC G06F 3/017

(57) ABSTRACT

A gesture recognition method for a motion sensing detector is disclosed and includes the following steps: activating the motion sensing detector of an electronic device; switching the electronic device from a first input mode into a second input mode when the motion sensing detector detects a first motion generated by at least one finger of a user; and executing an operation when the motion sensing detector detects a second motion generated by the at least one finger of the user in the second input mode.

### CROSS REFERENCE TO RELATED APPLICATION

This application claims priority to Taiwan Application Serial Number 103110650, filed on Mar. 21, 2014, which are herein incorporated by reference.

### FIELD OF THE INVENTION

The present invention relates to the field of gesture recognition, and more particularly relates to gesture recognition for a motion sensing detector.

### BACKGROUND OF THE INVENTION

With the progression of technology, how computers operate changes from time to time. Peripheral devices, such as keyboards, mice, or touch pads, have been continually released to solve the input operation problem faced by the user. In addition, with the increased popularity of the tablet device, the touch operation manner has become the main stream of current computers.

However, the touch operation manner requires directly touching the monitor of a normal computer, but the operation of a conventional computer requires a keyboard. If the touch operation is implemented in a conventional computer, both of the user's hands are required to move forward or backward between the monitor and the keyboard to finish jobs on the computer, which is very inconvenient.

Therefore, a need has arisen to design an operating manner adapted for the conventional desktop or laptop which will allow the user to finish works on the computer without moving forward or backward between the monitor and the keyboard.

### SUMMARY OF THE INVENTION

One objective of the present invention is to provide a gesture recognition method for a motion sensing detector which can be used to simulate an operation of a mouse or other peripheral devices to simplify the usage of the electronic device.

According to the aforementioned objective, a gesture recognition method for a motion sensing detector is disclosed herein and comprises the following steps: a step of activating the motion sensing detector of an electronic device, a step of switching a first input mode to a second input mode in the electronic device when the motion sensing detector detects a first motion generated by at least one finger of a user, and a step of executing an operation by the electronic device in the second input mode in accordance with a second motion generated by the at least one finger of the user.

Another objective of the present invention is to provide a gesture recognition method for a motion sensing detector which the user can operate the electronic device without touching the monitor.

According to the aforementioned objective, a gesture recognition method for a motion sensing detector is disclosed herein and comprises the following steps: a step of acquiring a first gesture image message from the motion sensing detector; a step of recognizing a first operation command corresponding to the first gesture image message, a step of switching a first input mode to a second input mode in an electronic device in accordance with the first operation command, a step of acquiring a second gesture image message from the motion sensing detector, a step of recognizing a second operation command corresponding the second gesture image message, and a step of executing an operation corresponding to the second operation command in the electronic device.

### DESCRIPTION OF THE DRAWINGS

FIG. 1 is a gesture recognition method in one embodiment of the present invention;

FIG. 2A˜FIG. 2F are views illustrating the gesture motions in the gesture recognition method of the present invention;

FIG. 3 is a flow chart of the gesture recognition method for the motion sensing detector in the present invention; and

FIG. 4 is a block diagram illustrating a gesture recognition system in the present invention.

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. In this regard, directional terminology, such as “top,” “bottom,” “front,” “back,” “left,” “right,” “inside,” “outside,” “side,” etc., is used with reference to the orientation of the Figure(s) being described. As such, the directional terminology is used for purposes of illustration and is in no way limiting the present invention.

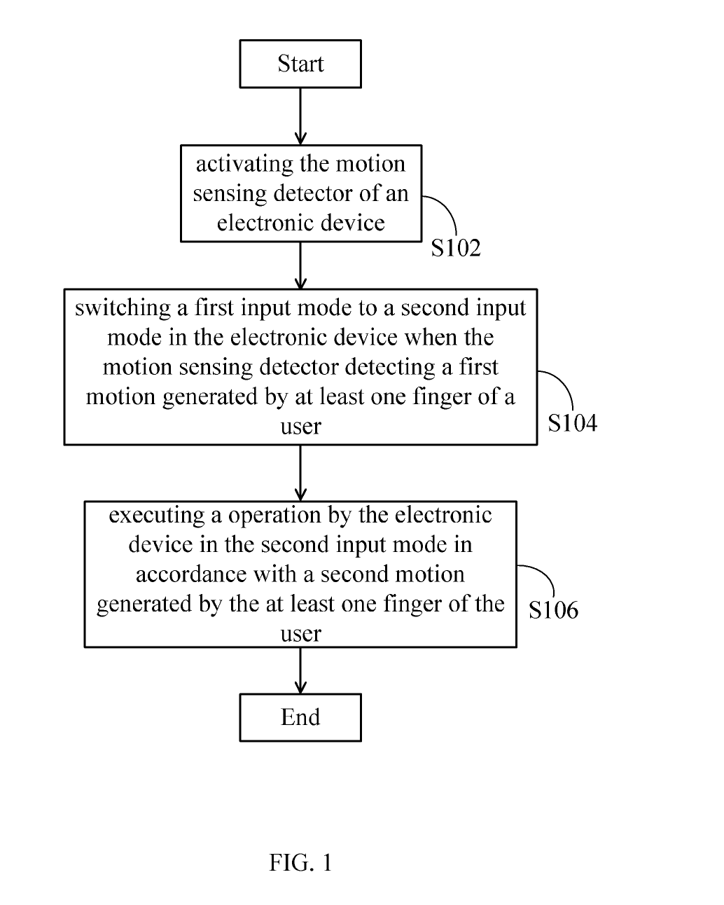

FIG. 1 is a gesture recognition method in one embodiment of the present invention. As shown in FIG. 1, the gesture recognition method in the present invention is to install a depth camera on the edge area of the monitor of the computer. The motion sensing detector can be implemented to recognize the motion of the fingers of the user to simulate the operation of the mouse or other peripheral devices. The motion sensing detector is made by a depth camera and a conventional camera. The depth camera can determine the distance between the object and the camera by calculating the time when an infrared ray transmitted by the depth camera hits the object. The relationship between the depth camera and the conventional camera also requires adjustments when shooting, so that the corresponding depth value of the images shot by the camera can be determined This allows the motion sensing detector tracking the motion of the finger. The operation of a conventional mouse can be simulated by recognizing the motion of the finger. Accordingly, the gesture recognition method in the present invention is as follows. In step S102, the motion sensing detector of the electronic device is activated. The motion sensing detector of the electronic device is activated to recognize the gesture of the user. The electronic device can recognize the gesture of the user to simulate the operation of the mouse. Before the gesture recognition method in the present invention is started, normally the user's fingers all put on the keyboard and typing. In step S104, when the motion sensing detector recognizes a first motion generated by the user's finger, the electronic device switches a first input mode to a second input mode. Generally, all of the user's fingers are put on the keyboard. One of the user's fingers raises upward about 45 degrees if the user would like to simulate the operation of the mouse. The user may use one finger or more than one finger, and the specific angle can be 45 degrees, but in a different embodiment, the specific angle can be any other degrees and it is not limited herein. When the user's finger raises upward about a specific angle, the motion sensing detector detects the motion of the finger and recognizes that the motion is for the electronic device to switch the first input mode to the second input mode. In the present embodiment, the first input mode is the keyboard input mode and the second input mode is the mouse input mode or other peripheral device input mode. In addition, in the second input mode, a conventional mouse cursor appears on the monitor of the computer. When the user's finger is moving, the mouse cursor on the monitor is also moving accordingly. Thereafter, in step S106, in the second input mode, the motion sensing detector detects a second motion generated by the user's finger, and a corresponding operation is executed in accordance with the second motion. In the second input mode, which is the input mode to simulate peripheral devices (such as mouse and so on), the user's finger generates the second motion, and the motion sensing detector detects the second motion and the computer executes the corresponding operation command in accordance with the second motion. For example, the second motion can be the finger of the user pointing downward, and the moving motion acted by the user's finger to simulate the motion of the left click in the mouse. The user's finger is preferred to be the forefinger. In a different embodiment, the second motion can be the user's finger pointing downward a couple of times to simulate the continuous clicking motion of the left button of the mouse. In a different embodiment, the second motion can be the user's finger moving forward or backward to simulate the motion at the middle wheel of the mouse. In a different embodiment, the second motion can be the user's forefinger and thumb moving open and close in order to have the monitor enlarge or shrink. In a different embodiment, the second motion can be the user's finger waving left or right to simulate the switching of windows in the operation system of the computer. If the user would like to switch the second input mode to the first input mode (the mouse simulating input mode to the keyboard input mode), the user's finger points downward a specific angle and the computer would switch the input modes.

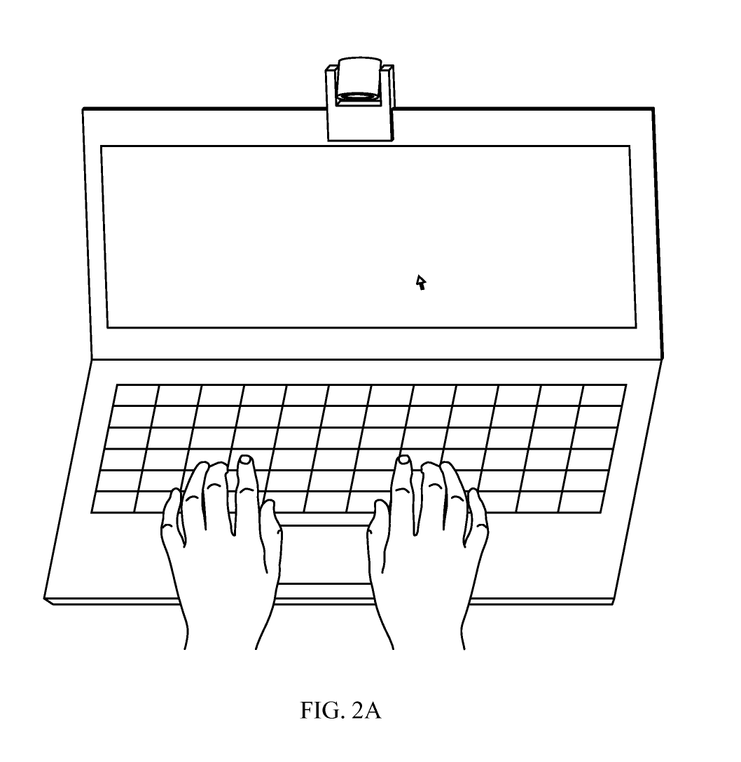

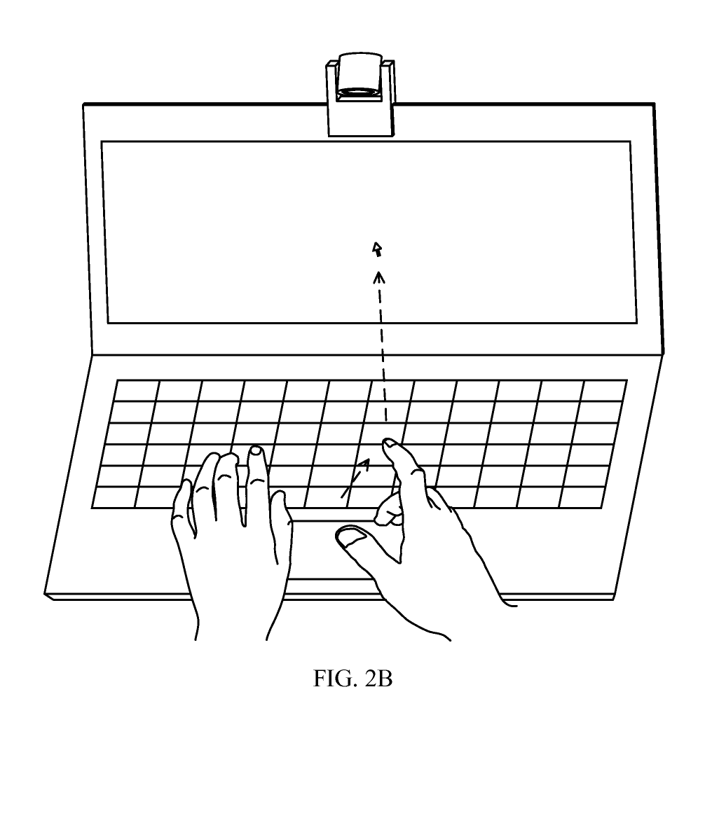

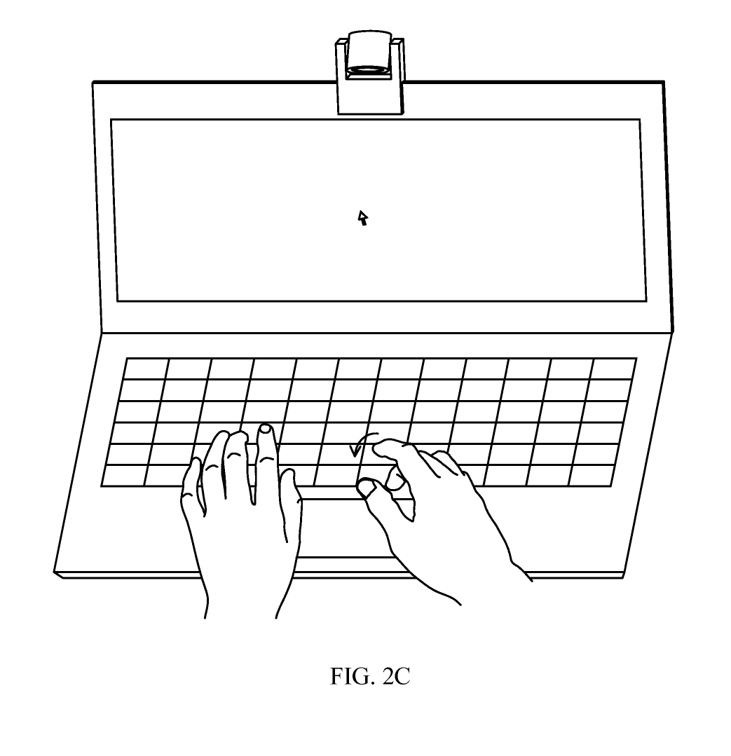

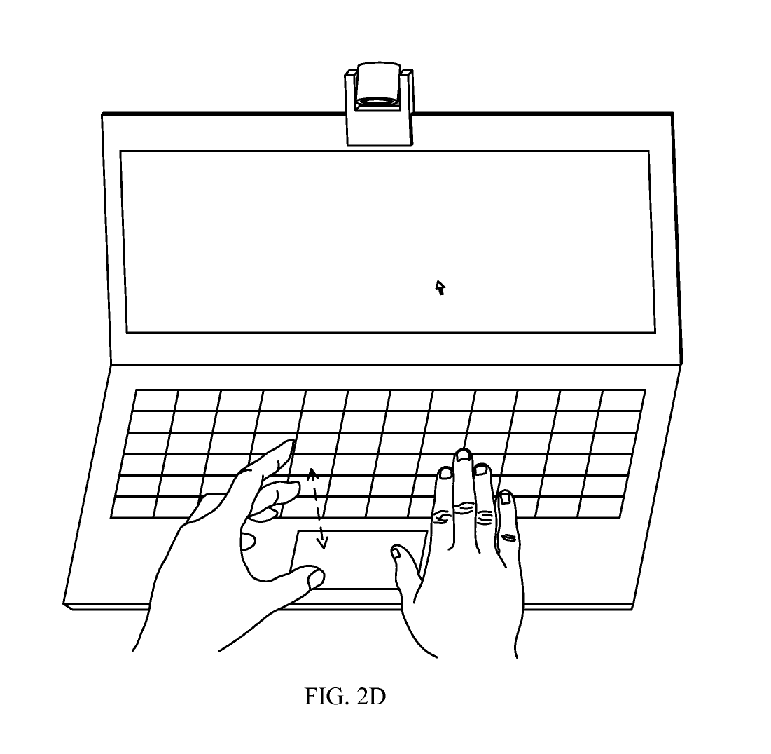

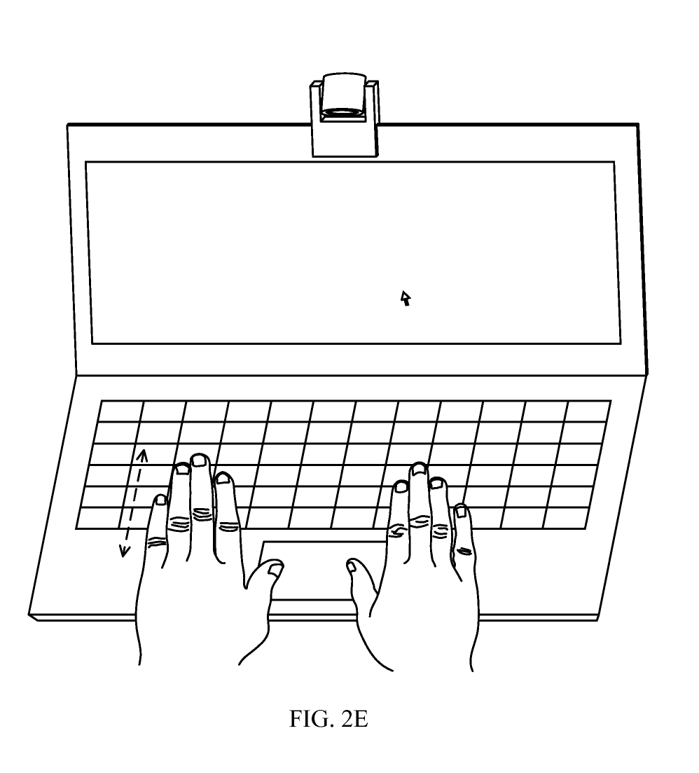

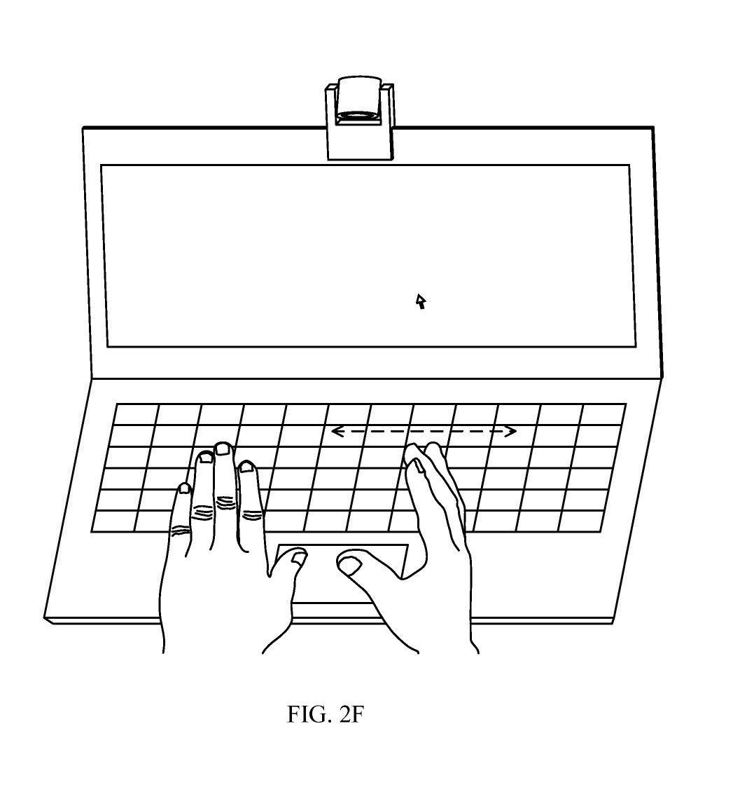

FIG. 2A˜FIG. 2F are views illustrating the gesture motions in the gesture recognition method of the present invention. As shown in FIG. 2A, when the user is using the computer, all of the fingers on both hands of the user are put on the keyboard and doing typing. When the user would like to switch the typing on the keyboard to a job on other peripheral devices of the computer, for example switching to simulate the operation of the mouse (as shown in FIG. 2B), the forefinger in the right hand of the user raises upward 45 degree. At this moment, the motion sensing detector of the computer will detect the moving motion of the finger in the right hand of the user. According to the setup within the computer, the moving motion of the finger detected by the motion sensing detector is recognized as the switching of the input mode. When the mouse cursor appears on the monitor of the computer, it is determined that the computer has been switched from the keyboard input mode to the simulating input mode for other peripheral devices. The other peripheral device can be a mouse, a writing tablet, or any other peripheral devices able to be used on the computer. It is not limited herein. Then, when the user's finger points downward one time, the motion sensing detector will recognize it as the simulation of one click on the left button of the mouse, as shown in FIG. 2C. Alternatively, if the finger of the user points downward a couple of times, the motion sensing detector will recognize it as the simulation of several clicks on the left button of the mouse. Moreover, if the user would like to enlarge or shrink the display fonts or the size of the pictures on the monitor, the user's forefinger and thumb can move open and close. When the motion sensing detector detects the motion of the open and close movement in the user's forefinger and thumb, the motion signal is transmitted to the computer and the computer will enlarge or shrink the display fonts or the size of the pictures on the monitor, as shown in FIG. 2D. In addition, it should be noted that the open and close movement of the user's forefinger and thumb can be the right forefinger and the right thumb or the left forefinger and the left thumb, and it is not limited herein. Moreover, when the motion of the middle wheel of the mouse is simulated to browse pages, as shown in FIG. 2E, four fingers on the user's left hand move longitudinally backward to simulate the backward movement of the middle wheel to move the page down. When the four fingers on the left hand of the user to move longitudinally forward, the forward movement of the middle wheel to move the page up is simulated. However, in a different embodiment, the user can also use the right hand to simulate the operation of the middle wheel of the mouse, and it is not limited herein. As shown in FIG. 2F, when the user's fingers wave left or right, the computer will recognize it as the switching command for the windows of the operating system. When the user's finger waves left or right one time, the window of the operating system will be switched one time. The number of the user's fingers waving left or right can be one finger waving left or right one time, or more than two fingers of the user waving left or right one time.

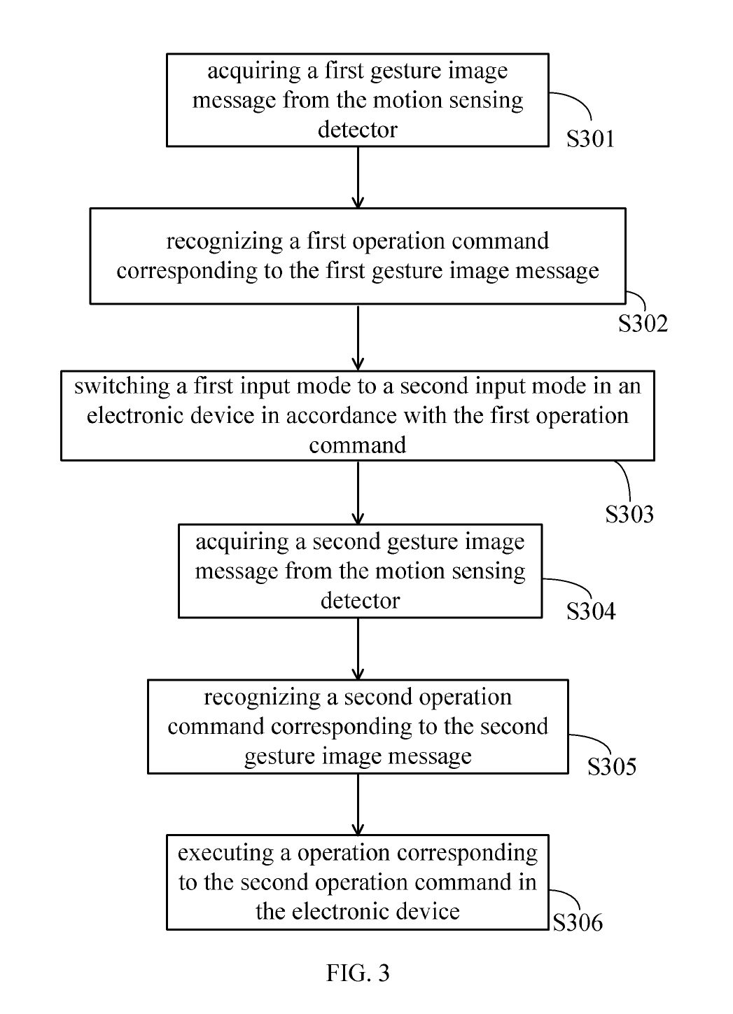

FIG. 3 is a flow chart of the gesture recognition method for the motion sensing detector in the present invention. As shown in FIG. 3, the gesture recognition method for the motion sensing detector in the embodiment includes the following steps. In step S301, a first gesture image message is detected by the motion sensing detector and the motion sensing detector will detect the movement of the gesture and compare the gesture thereof with the gesture commands stored in the electronic device. In step S302, a first operation command corresponding to the first gesture image message is recognized. According to the gesture commands stored in the computer, the first operation command corresponding to the first gesture image message is determined. Then, in step S303, an electronic device is switched from a first input mode to a second input mode in accordance with the first operation command. When the electronic device recognizes the command representing the first gesture image message, the electronic device is switched from the first input mode to the second input mode. For example, the first input mode is the keyboard input mode. When the electronic device recognizes the first gesture image message of the user, the keyboard input mode is switched to the second input mode. The second input mode can be the mouse simulating input mode or a touch simulating input mode, and it is not limited herein. Thereafter, in step S304, a second gesture image message is detected by the motion sensing detector. In the second input mode, the motion sensing detector detects the second gesture image message of the user. In step S305, a second operation command corresponding to the second gesture image message is determined After the motion sensing detector detects the second gesture image message, the electronic device compares the second gesture image message with the gesture commands stored within the electronic device to find the corresponding second operation command. Finally, in step S306, the operation corresponding to the second operation command is executed by the electronic device. The aforementioned second operation command can be the operation for simulating the operation for the left button of the mouse, the operation for the middle wheel of the mouse, the operation for switching windows, or the operation for enlarging or shrinking the display page, and it is not limited herein. Moreover, it should be noted that the motion sensing detector for the gesture recognition method in the present invention is preferred to include a depth camera. The electronic device in the embodiment of the present invention is preferred to be a desktop or laptop, but can be a tablet with a keyboard and it is not limited herein.

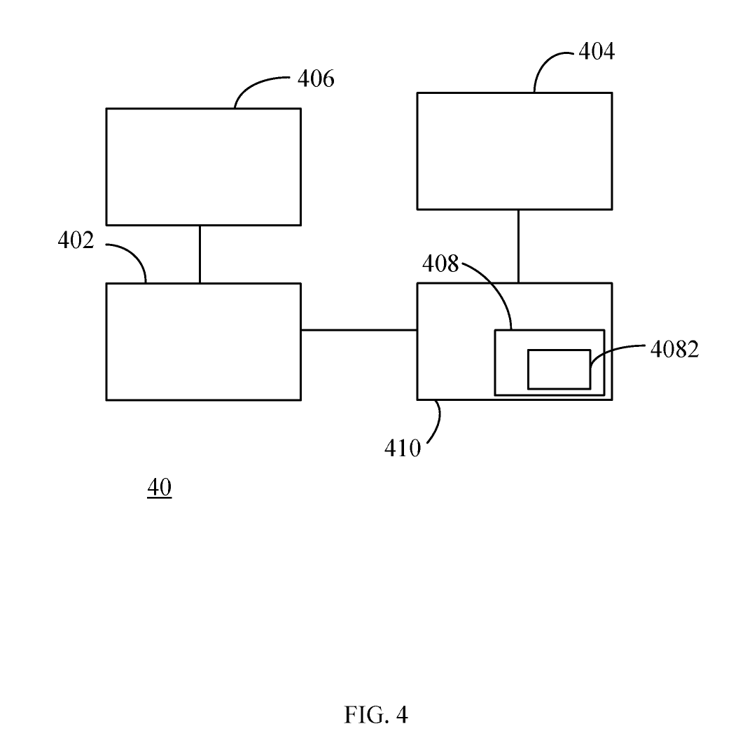

FIG. 4 is a block diagram illustrating a gesture recognition system in the present invention. As shown in FIG. 4, the gesture recognition system includes a monitor 402, a keyboard 404, a motion sensing detector 406, recognition software 408, and a computer 410. The monitor 402 and the keyboard 404 are respectively connected to the computer 410, and the motion sensing detector 406 is disposed on top of the monitor 402. In addition, the motion sensing detector is preferred to include a depth camera configured for detecting the gesture motion image of the user in front of the monitor and on top of the keyboard, and the gesture image message is transmitted to the recognition software 408. The recognition software 408 is pre-installed in the computer 410. The gesture image message detected by the motion sensing detector 406 is transmitted to the recognition software 408, and the recognition software 408 compares the gesture image message with the gesture image messages pre-stored in a database 4082 within the recognition software 408. If the recognition software 408 finds the corresponding gesture image message in the database 4082, the command corresponding to the gesture image message is executed.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A gesture recognition method for a motion sensing detector, comprising steps of:
activating the motion sensing detector of an electronic device;
switching a first input mode to a second input mode in the electronic device when the motion sensing detector detects a first motion generated by at least one finger of a user; and
executing an operation by the electronic device in the second input mode in accordance with a second motion generated by the at least one finger of the user.

2. The gesture recognition method for a motion sensing detector according to claim 1, wherein the first motion is the at least one finger of the user raising upward an angle.

3. The gesture recognition method for a motion sensing detector according to claim 1, wherein the second motion is the at least one finger of the user pointing downward once to simulate one click in a left button of a mouse.

4. The gesture recognition method for a motion sensing detector according to claim 1, wherein the second motion is the at least one finger of the user pointing downward several times to simulate several clicks in a left button of a mouse.

5. The gesture recognition method for a motion sensing detector according to claim 1, wherein the second motion is the at least one finger moving along a longitudinal direction forward or backward to simulate an operation on a middle wheel of a mouse.

6. The gesture recognition method for a motion sensing detector according to claim 1, wherein the second motion is a forefinger and a thumb moving close and open to simulate enlarging or shrinking a window.

7. A gesture recognition method for a motion sensing detector, comprising steps of:
acquiring a first gesture image message from the motion sensing detector;
recognizing a first operation command corresponding to the first gesture image message;
switching a first input mode to a second input mode in an electronic device in accordance with the first operation command;
acquiring a second gesture image message from the motion sensing detector;
recognizing a second operation command corresponding to the second gesture image message; and
executing an operation corresponding to the second operation command in the electronic device.

8. The gesture recognition method for a motion sensing detector according to claim 1, wherein the motion sensing detector includes a depth camera.

9. The gesture recognition method for a motion sensing detector according to claim 1, wherein the first input mode is a keyboard input mode.

10. The gesture recognition method for a motion sensing detector according to claim 1, wherein the first motion is the at least one finger of the user raising upward at an angle.

11. The method according to claim 1, wherein the second motion is the at least one finger of the user pointing downward once to simulate one click in a left button of a mouse.

12. The method according to claim 7, wherein the second motion is the at least one finger of the user pointing downward several times to simulate several clicks in a left button of a mouse.

13. The method according to claim 7, wherein the second motion is the at least one finger moving along a longitudinal direction forward or backward to simulate an operation on a middle wheel of a mouse.

14. The method according to claim 7, wherein the second motion is a forefinger and a thumb moves close and open to simulate to zoom in and out of a window.
